(19) United States
(12) Patent Application Publication
(10) Pub. No.: US 2026/0281773 A1
(43) Pub. Date: Sep. 17, 2026

(54) METHODS, APPARATUSES AND SYSTEMS FOR USER EQUIPMENT MEASUREMENT AND REPORTING

(71) Applicant: ZTE CORPORATION, Shenzhen (CN)

(72) Inventors: Xuan MA, Shenzhen (CN); Mengzhu CHEN, Shenzhen (CN); Bo DAI, Shenzhen (CN); Jun XU, Shenzhen (CN); Xiaoying MA, Shenzhen (CN)

(73) Assignee: ZTE CORPORATION, Shenzhen (CN)

(21) Appl. No.: 19/167,801

(22) PCT Filed: Apr. 3, 2023
(86) PCT No.: PCT/CN2023/085927

§ 371 Date: Sep. 22, 2025

(51) Int. Cl. H04W 24/10; H04B 7/06; H04L 5/00; H04W 24/08

(52) U.S. Cl. CPC H04W 24/10; H04L 5/0048; H04W 24/08; H04B 7/0626

(57) ABSTRACT

Methods, apparatus and systems for user equipment measurement and report are described. In one embodiment, a method performed by a first wireless communication node, includes: transmitting a first signaling to a first wireless communication device, wherein the first signaling includes one or more resource configurations; and receiving a plurality of reports from the first wireless communication device, wherein the plurality of reports is generated based on a plurality of measurements performed by the first wireless communication device, wherein the plurality of measurements is performed based on the first signaling.

### TECHNICAL FIELD

The disclosure relates generally to wireless communications and, more particularly, to methods, apparatuses and systems for user equipment measurement and reporting.

### BACKGROUND

In new radio (NR), a beam of a cell may degrade due to various reasons especially in higher frequencies, e.g., due to beam blockage, beam misalignment or changes in radio environment such that the current beam does not provide adequate quality for communication. In case the current beam cannot be used, user equipment (UE) may choose to use an alternative beam from the same cell that is usable. When there exists alternative beam(s) for communication, the connection between the UE and the network should be recovered via beam recovery procedure.

For beam management, the UE measures beam-specific reference signals such as channel state information reference signal (CSI-RS). Based on the measured reference signals, the UE may report detected beams to a base station (BS) according to a network configuration. Upon receiving the reported beams from the UE, the BS may indicate the UE the beams for physical downlink control channel (PDCCH) monitoring. Then the UE may be configured with multiple PDCCH beams for robustness: in case one PDCCH beam fails, alternative beams may be used. Beam failures may be detected at the UE side by counting beam failure instances at a lower layer such as the physical layer and indicating the beam failure instances to a higher layer such as the media access control (MAC) layer. The physical layer of the UE may provide a failure indication to higher layers when the radio link quality for all corresponding resource configurations used by the UE is worse than a predetermined threshold value.

In a current 5G NR system, the small wavelengths of high frequency signals enable large number of miniaturized antennas to be placed in the BS. The miniaturized antenna system can form very high gain, electrically steerable arrays and generate high directional transmissions through beamforming. On the other hand, the greenhouse gas emission caused by 5G BSs and large power consumption has become a serious issue with the deployment of 5G NR systems. To reduce the power consumption, one potential method is to reduce the number of base station spatial adaptation patterns, e.g. the number of antenna ports or active transceiver chains during communication. However, dynamic changes of the number of base station spatial adaptation patterns during communication may affect the UE channel state information (CSI) measurements and CSI reporting for beam management. Consequently, conventional methods for handling UE CSI measurements and reporting for beam management are not entirely satisfactory. Therefore, there is a need to develop new methods for handling UE CSI measurements and reporting for beam management given dynamic changes of base station spatial elements.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In some embodiments, a method performed by a first wireless communication node, includes: transmitting a first signaling to a first wireless communication device, wherein the first signaling includes one or more resource configurations and a plurality of threshold sets; and receiving a plurality of reports from the first wireless communication device, wherein the plurality of reports is generated based on a plurality of measurements performed by the first wireless communication device, wherein the plurality of measurements is performed based on the first signaling.

In some embodiments, the first signaling further includes: at least one first power offset, wherein the at least one first power offset is a ratio of a non-zero power (NZP) CSI-RS energy per resource element (EPRE) and a synchronization signal/physical broadcast channel (SS/PBCH) block EPRE; at least one second power offset, wherein the at least one second power offset is a compensated power offset of the NZP CSI-RS EPRE to the SS/PBCH block EPRE; one or more predefined parameters, wherein the one or more predefined parameters comprise at least one of: one or more physical downlink control channel (PDCCH) transmission parameters for beam failure detections; one or more PDCCH transmission parameters for out-of-synchronization (out-of-sync) evaluations; one or more PDCCH transmission parameters for in-synchronization (in-sync) evaluations; and one or more resources grouping parameters; and a number of transmission configuration indicator (TCI) states.

In some embodiments, the plurality of threshold sets includes: a first threshold set comprising at least one first threshold, wherein the at least one first threshold is associated with at least one of: a corresponding first spatial adaptation pattern from the plurality of spatial adaptation patterns; a power offset value set; a block error rate (BLER) of a hypothetical physical downlink control channel (PDCCH) transmission; a plurality of hypothetical PDCCH transmission parameters; and a first downlink radio link quality of a plurality of serving cell beams; a second threshold set comprising at least one second threshold, wherein the at least one second threshold is associated with at least one of: a corresponding second spatial adaptation pattern from the plurality of spatial adaptation patterns; a first downlink radio link quality of a cell, and an out-of-synchronization (out-of-sync) BLER; a third threshold set comprising at least one third threshold, wherein the at least one third threshold is associated with at least one of: a corresponding third spatial adaptation pattern from the plurality of spatial adaptation patterns; a second downlink radio link quality of the cell, and an in-synchronization (in-sync) BLER; and a fourth threshold set comprising at least one fourth threshold, wherein the at least one fourth threshold is associated with at least one of: a corresponding fourth spatial adaptation pattern from the plurality of spatial adaptation patterns; a second downlink radio link quality of a beam, and a power value.

In some embodiments, the plurality of measurements is associated with at least one of: a plurality of CSI resources; a plurality of sub-CSI resource configurations; a plurality of radio link monitoring (RLM) resource configurations; a plurality of SSB resources; and one or more sets of power offsets between an SSB and a CSI reference signal (RS).

In some embodiments, the plurality of reports includes at least one of: one or more layer-1 reference signal received power (L1-RSRP) reports; one or more layer-1 signal-to-noise and interference ratio (L1-SINR) reports; one or more beam failure instance indications; one or more out-of-synchronization (out-of-sync) indications; one or more in-synchronization (in-sync) indications; one or more beam failure recovery indications; a maximum acceptable power adaptation value; and at least one acceptable spatial adaptation pattern from the plurality of spatial adaptation patterns.

In some embodiments, the at least one first threshold is set to 10% block error rate, the at least one second threshold is set to 10% block error rate, the at least one third threshold is set to 2% block error rate, and the plurality of hypothetical PDCCH transmission parameters comprises at least one of: a plurality of control orthogonal frequency-division multiplexing (OFDM) symbols; an aggregation level; one or more hypothetical PDCCH resource element (RE) energy to average secondary synchronization signal (SSS) RE energy ratios; one or more hypothetical PDCCH demodulation reference signal (DMRS) energy to average SSS RE energy ratios; one or more hypothetical PDCCH RE energy to average CSI-RS RE energy ratios; one or more hypothetical PDCCH DMRS RE energy to average CSI-RS RE energy ratios; a bandwidth; a sub-carrier spacing; a DMRS precoder granularity; a resource element group (REG) bundle size; a cyclic prefix (CP) length; and a mapping method from REG to control channel element (CCE).

In some embodiments, the at least one acceptable spatial adaptation pattern is associated with a hypothetical physical downlink control channel (PDCCH) transmission with no radio link failures or no beam failures.

In some embodiments, each of the plurality of spatial adaptation patterns comprises: a first number of active antennas used in a communication between the first wireless communication node and the first wireless communication device; a second number of activated channels used in the communication between the first wireless communication node and the first wireless communication device; a third number of active antenna ports used in the communication between the first wireless communication node and the first wireless communication device; a fourth number of active transceiver chains used in the communication between the first wireless communication node and the first wireless communication device; and a fifth number of resource configurations for communication between the first wireless communication node and the first wireless communication device.

In some embodiments, each of: the one or more beam failure instance indications, the one or more out-of-sync indications, the one or more in-sync indications, and one or more beam failure recovery indications is based on at least one of: the first signaling; one or more L1-RSRP values; the plurality of threshold sets; and one or more predefined parameters.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates an exemplary wireless communication network, in accordance with some embodiments of the present disclosure.

FIG. 1B illustrates a block diagram of an exemplary wireless communication system, in accordance with some embodiments of the present disclosure.

FIG. 2 illustrates another exemplary wireless communication network, in accordance with some embodiments of the present disclosure.

FIG. 3 illustrates a signaling diagram between a base station and a user equipment for performing a method for channel state information measurement and reporting, in accordance with some embodiments.

FIG. 4 illustrates an example method for performing channel state information measurements and reporting, in accordance with some embodiments.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

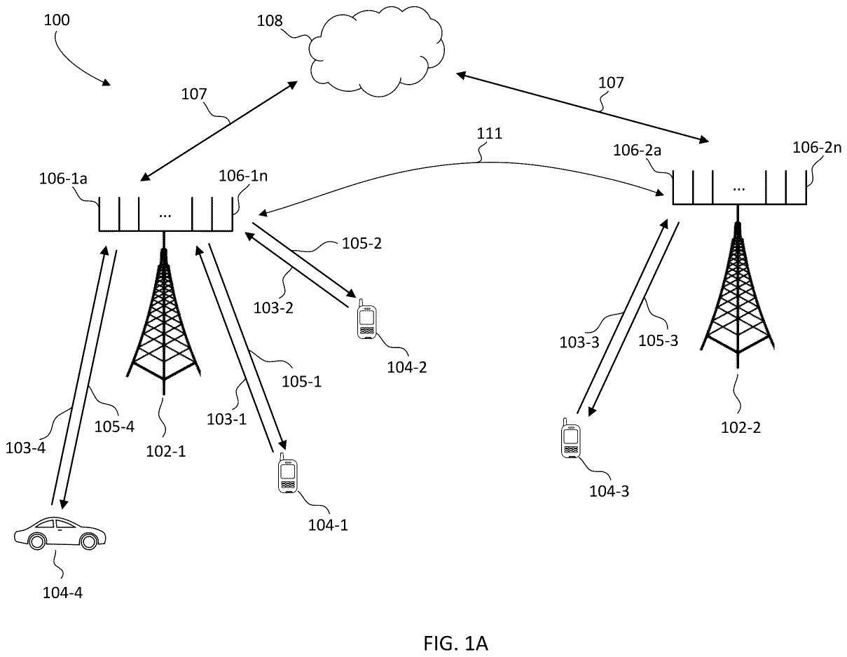

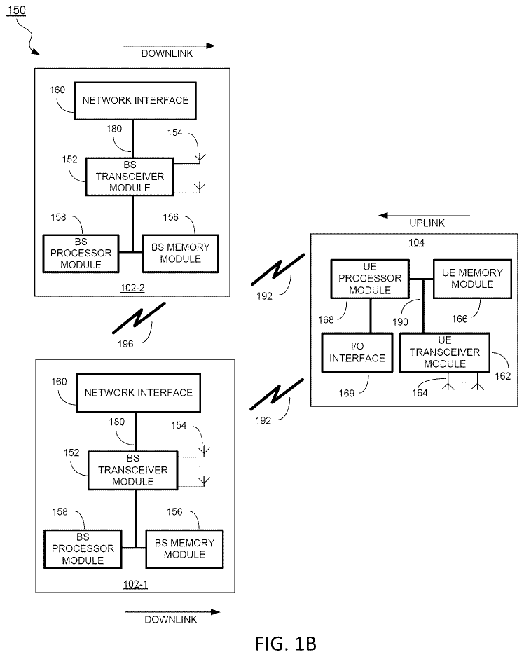

FIG. 1A illustrates an exemplary wireless communication network 100, in accordance with some embodiments of the present disclosure. In a wireless communication system, a network side communication node or a base station (BS) 102 can be a node B, an E-UTRA Node B (also known as Evolved Node B, eNodeB or eNB), a New Generation eNB (ng-eNB), a gNodeB (also known as gNB) in new radio (NR) technology, a pico station, a femto station, or the like. A terminal side communication device or a user equipment (UE) 104 can be a long range communication system like a mobile phone, a smart phone, a personal digital assistant (PDA), tablet, laptop computer, or a short range communication system such as, for example a wearable device, a vehicle with a vehicular communication system and the like. A network communication node and a terminal side communication device are represented by a BS 102 and a UE 104, respectively, and in all the embodiments in this disclosure hereafter, and are generally referred to as “communication nodes” and “communication device,” respectively, herein. Such communication nodes and communication devices are capable of wireless communications, in accordance with various embodiments of the invention. It is noted that all the embodiments are merely preferred examples and are not intended to limit the present disclosure. Accordingly, it is understood that the system may include any desired combination of BSs 102 and UEs 104, while remaining within the scope of the present disclosure.

Referring to FIG. 1A, the wireless communication network 100 includes a first BS 102-1, a second BS 102-2, a first UE 104-1, a second UE 104-2, a third UE 104-3, and a fourth UE 104-4. In some embodiments, the first BS 102-1 and the second BS 102-2 comprise a first plurality of antennas 106-1a to 106-1n and a second plurality of antennas 106-2a to 106-2n, respectively. The first plurality of antennas 106-1a to 106-1n may communicate with one or more of the plurality of UEs 104 to form a first MIMO system, and the second plurality of antennas 106-2a to 106-2n may communicate with one of more of the plurality of UEs 104 to form a second MIMO system.

In some embodiments, the plurality of UEs 104 may form direct communication links, such as uplink channels 103-1, 103-2, 103-3, and 103-4 and downlink channels 105-1, 105-2, 105-3, and 105-4 with the first BS 102-1 and/or the second BS 102-2. The direct communication channels between the plurality of UEs 104 and one or more of the BS's 102 can be through interfaces such as an Uu interface, which is also known as E-UTRAN air interface. In some embodiments, the UE 104 comprises a plurality of transceivers which enables the UE 104 to support multi connectivity so as to receive data simultaneously from the first BS 102-1 and the second BS 102-2. Each of the first BS 102-1 and the second BS 102-2 is connected to a core network (CN) 108 on a user plane (UP) through an external interface 107, e.g., an Iu interface, an NG-U interface, or an S1-U interface. In some embodiments, the CN 108 is one of the following: an Evolved Packet Core (EPC) and a 5G Core Network (5GC). In some embodiments, the CN 108 further comprises at least one of the following: Access and Mobility Management Function (AMF), User Plane Function (UPF), and System Management Function (SMF). In some embodiments, the CN 108 can provide cloud-computing functionality by providing one or more databases and/or servers for storing and processing data and/or instructions to perform machine learning processes, as described in further detail below.

A direct communication channel 111 between the first BS 102-1 and the second BS 102-2 is through an X2 interface. In some embodiments, a BS (e.g., a gNB) is split into a Distributed Unit (DU) and a Central Unit (CU) on the UP, between which the direct communication is through a F1-U interface. In some embodiments, a CU of the second BS 102-2 can be further split into a Control Plane and a User Plane (UP), between which the direct communication is through an E1 interface. Hereinafter in the present disclosure, an Xx interface is used to describe one of the following interfaces, the NG interface, the S1 interface, the X2 interface, the Xn interface, the F1 interface, and the E1 interface. When an Xx interface is established between two nodes, the two nodes can transmit control signaling on the control panel and/or data on the UP.

FIG. 1B illustrates a block diagram of an exemplary wireless communication system 150, in accordance with some embodiments of the present disclosure. The system 150 may include components and elements configured to support known or conventional operating features that need not be described in detail herein. In some embodiments, the system 150 can be used to transmit and receive data symbols in a wireless communication environment such as the wireless communication network 100 of FIG. 1A, as described above.

The system 150 generally includes a first BS 102-1, a second BS 102-2, and a UE 104, collectively referred to as BS 102 and UE 104 below for ease of discussion. The first BS 102-1 and the second BS 102-2 each comprises a BS transceiver module 152, a BS antenna array 154, a BS memory module 156, a BS processor module 158, and a network interface 160. In the illustrated embodiment, each module of the BS 102 is coupled and interconnected with one another as necessary via a data communication bus 180. The UE 104 comprises a UE transceiver module 162, a UE antenna 164, a UE memory module 166, a UE processor module 168, and an I/O interface 169. In the illustrated embodiment, each module of the UE 104 is coupled and interconnected with one another as necessary via a data communication bus 190. The BS 102 communicates with the UE 104 via a communication channel 192, which can be any wireless channel suitable for transmission of data as described herein.

As would be understood by persons of ordinary skill in the art, the system 150 may further include any number of BS's, UE's or modules other than those shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

A wireless transmission from a transmitting antenna of the UE 104 to a receiving antenna of the BS 102 is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a radio frequency (RF) transmitter and receiver circuitry that is each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. Preferably, there is close synchronization timing with only a minimal guard time between changes in duplex direction. The UE transceiver 162 communicates through the UE antenna 164 with the BS 102 via the wireless communication channel 192. The BS transceiver 152 communications through the BS antenna 154 of a BS (e.g., the first BS 102-1) with the other BS (e.g., the second BS 102-2) via a wireless communication channel 196. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long Term Evolution (LTE) and emerging 5G standards (e.g., NR), and the like. It is understood, however, that the invention is not necessarily limited in application to a particular standard and associated protocols. Rather, the UE transceiver 162 and the BS transceiver 152 may be configured to support alternate, or additional, wireless data communication protocols, including future standards or variations thereof.

The processor modules 158 and 168 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

Referring again to FIG. 1A, as mentioned above, the BS 102 repeatedly broadcasts system information associated with the BS 102 to one or more UEs 104 so as to allow the UEs 104 to access the network within the cells where the BS 102 is located, and in general, to operate properly within the cell. Plural information such as, for example, downlink and uplink cell bandwidths, downlink and uplink configuration, cell information, configuration for random access, etc., can be included in the system information. Typically, the BS 102 broadcasts a first signal carrying some major system information, for example, configuration of the cell where the BS 102 is located through a Physical Broadcast Channel (PBCH). For purposes of clarity of illustration, such a broadcasted first signal is herein referred to as “first broadcast signal.” It is noted that the BS 102 may subsequently broadcast one or more signals carrying some other system information through respective channels (e.g., a Physical Downlink Shared Channel (PDSCH)).

Referring again to FIG. 1B, in some embodiments, the major system information carried by the first broadcast signal may be transmitted by the BS 102 in a symbol format via the communication channel 192 (e.g., a PBCH). In accordance with some embodiments, an original form of the major system information may be presented as one or more sequences of digital bits and the one or more sequences of digital bits may be processed through plural steps (e.g., coding, scrambling, modulation, mapping steps, etc.), all of which can be processed by the BS processor module 158, to become the first broadcast signal. Similarly, when the UE 104 receives the first broadcast signal (in the symbol format) using the UE transceiver 162, in accordance with some embodiments, the UE processor module 168 may perform plural steps (de-mapping, demodulation, decoding steps, etc.) to estimate the major system information such as, for example, bit locations, bit numbers, etc., of the bits of the major system information. The UE processor module 168 is also coupled to the I/O interface 169, which provides the UE 104 with the ability to connect to other devices such as computers. The I/O interface 169 is the communication path between these accessories and the UE processor module 168.

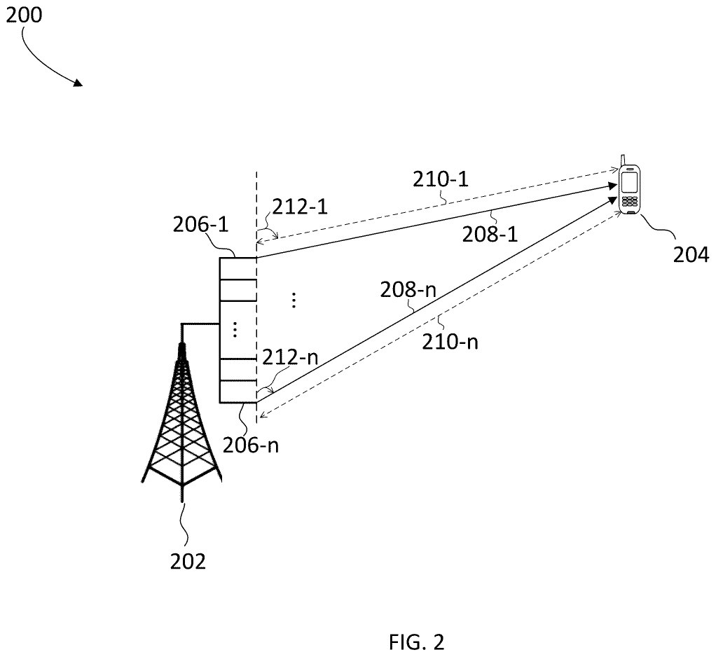

FIG. 2 illustrates another exemplary wireless communication network 200, in accordance with some embodiments of the present disclosure. In some embodiments, the exemplary wireless communication network 200 comprises a BS 202 and a UE 204. In some embodiments, the BS 202 comprises a plurality of antennas 206-1 to 206-n as shown. The plurality of antennas 206-1 to 206-n may be arranged in an antenna array and be in communication with the UE 204 to form a multiple input and single output (MISO) system. In some embodiments, the plurality of antennas 206-1 to 206-n is configured to form a uniform linear antenna array. In some other embodiments, the plurality of antennas 206-1 to 206-n may form a planar antenna array or a frequency scanning antenna array. Although FIG. 2 illustrates an embodiment of a MISO system, the present disclosure is not limited to MISO systems, and can be applied to other types of communication systems, such as MIMO systems, single input multiple output (SIMO) systems, and single input single output (SISO) systems.

In some embodiments, the antennas in the plurality of antennas 206-1 to 206-n are evenly spaced on a straight line, wherein each pair of neighbored antennas has a fixed distance. In some other embodiments, the antennas in the plurality of antennas 206-1 to 206-n are arranged on a straight line, wherein different pairs of neighbored antennas have different distances. In some embodiments, each of the plurality of antennas 206-1 to 206-n may be in communication with the UE 204 through a respective channel of a plurality of channels 208-1 to 208-n, and each of the plurality of antennas 206-1 to 206-n has a respective distance 210 from the UE 204. Each of the plurality of antennas 206-1 to 206-n may also have a respective angle of departure 212 corresponding to the respective channel of the plurality of channels 208-1 to 208-n.

In some embodiments, to reduce the total power consumption caused by the plurality of antennas 206-1 to 206-n during the communication between the BS 202 and the UE 204, at least one of the plurality of antennas 206-1 to 206-n may be disabled, such that at least a corresponding one of the plurality of channels 208-1 to 208-n may be disabled. In some embodiments, a number of active spatial adaptation patterns in the BS 202 corresponds to the number of enabled antennas from the plurality of antennas 206-1 to 206-n during the communication between the BS 202 and the UE 204. In some other embodiments, the number of active spatial adaptation patterns in the BS 202 corresponds to a total number of activated antenna ports or active transceivers chains used in the communication. The number of active spatial adaptation patterns in the BS 202 may dynamically change during the communication. For example, assume the total number of available spatial adaptation patterns in the BS 202 is n. Then at 5 different time points [t₁, t₂, t₃, t₄, t₅] during the communication, the corresponding number of active spatial adaptation patterns in the BS 202 may be [n₁, n₂, n₃, n₄, n₅], wherein n₁≤n, n₂≤n, n₃≤n, n₄≤n, and n₅≤n. Although 5 time points are given in the exemplary embodiment, the present disclosure is not limited to the case of 5 time points, and can be applied to other number of time points during the communication. The dynamic changes of the number of spatial adaptation patterns in the BS 202 may result in changes of UE CSI measurement and reporting configurations, as described in further detail below.

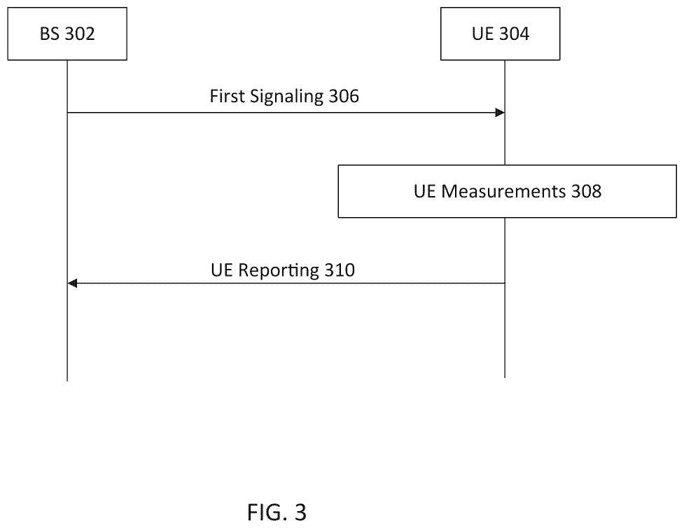

FIG. 3 illustrates a signaling diagram between a BS 302 and a UE 304 for performing a method for CSI measurement and reporting, in accordance with some embodiments. In some embodiments, the BS 302 may be configured to transmit a first signaling 306 to the UE 304. Upon receiving the first signaling 306, the UE 304 may be configured to perform a plurality of UE measurements 308 based on the first signaling 306, and transmit a plurality of UE reports 310 back to the BS 302, wherein the plurality of UE reports 310 is generated based on the plurality of UE measurements 308.

In some embodiments, the first signaling 306 comprises at least one of: one or more CSI resource configurations, one or more sub-CSI resource configurations, one or more synchronization signal block (SSB) resource configurations, one or more radio link monitoring reference signal (RLM-RS) resource configurations, a first set of power offsets, a second set of power offsets, one or more predefined parameters, a first threshold set, a second threshold set, a third threshold set, a fourth threshold set, and a number of transmission configuration indicator (TCI) states.

In some embodiments, the one or more CSI resource configurations comprise at least one of: one or more sub-CSI resources, one or more CSI-RS resources, one or more CSI-RS resource sets, and one or more CSI-RS resource settings. In some embodiments, each of the one or more CSI-RS resources is associated with one corresponding spatial adaptation pattern, wherein the one corresponding spatial adaptation pattern is associated with at least one of: a number of active antennas used in the communication between the BS 302 and the UE 304, a number of activated channels used in the communication between the BS 302 and the UE 304, a number of active antenna ports used in the communication between the BS 302 and the UE 304, a number of active transceiver chains used in the communication between the BS 302 and the UE 304, and a number of resource configurations for communication between the BS 302 and the UE 304.

In some embodiments, one or more sub-CSI resource configurations may be configured within at least one of the one or more CSI resource configurations, wherein each of the one or more sub-CSI resource configurations comprises one or more CSI-RS resources, one or more CSI-RS resource sets, and one or more CSI-RS resource settings. In some embodiments, each of the one or more sub-CSI resource configurations is associated with one corresponding spatial adaptation pattern. The definition and exemplary embodiments of the spatial adaptation pattern are described above and are, therefore, not repeated here.

In some embodiments, each of the one or more SSB resource configurations is associated with a corresponding spatial adaptation pattern. The definition and exemplary embodiments of the spatial adaptation pattern are described above and are, therefore, not repeated here.

In some embodiments, each of the one or more RLM-RS resource configurations comprises at least one of: one or more RLM-RS resources, failure detection resources, wherein the one or more RLM-RS resources can be all SSB resources, all CSI-RS resources, or a mixture of SSB and CSI-RS resources. In some embodiments, each of the one or more RLM-RS resource configurations is associated with a corresponding spatial adaptation pattern. The definition and exemplary embodiments of the spatial adaptation pattern are described above and are, therefore, not repeated here.

In some embodiments, the first set of power offsets comprises at least one first power offset, wherein the at least one first power offset is the ratio between the non-zero power (NZP) CSI-RS energy per resource element (EPRE) and the synchronization signals (SS)/physical broadcast channel (PBCH) block EPRE. In some embodiments, each of the at least one first power offset is associated with a corresponding spatial adaptation pattern. The definition and exemplary embodiments of the spatial adaptation pattern are described above and are, therefore, not repeated here. In some embodiments, the at least one first power offset is configured within one or more CSI resources, wherein each of the one or more CSI resources comprises at least one of: one or more CSI-RS resources, one or more CSI-RS resource sets, and one or more CSI-RS resource settings. In some other embodiments, the at least one first power offset is configured within one or more sub-CSI resources, wherein each of the one or more sub-CSI resources comprises at least one of: one or more CSI-RS resources, one or more CSI-RS resource sets, and one or more CSI-RS resource settings.

In some embodiments, the second set of power offsets comprises at least one second power offset, wherein the at least one second power offset is the compensated power offset of NZP CSI-RS EPRE to SS/PBCH block EPRE. In some embodiments, the compensated power offset of NZP CSI-RS EPRE to SS/PBCH block EPRE is determined as the compensation of the assumed ratio of NZP CSI-RS EPRE to SS/PBCH block EPRE for compensating the power difference caused by spatial adaptation patterns when the CSI-RS and/or SSB are configured for layer-1 reference signal received power (L1-RSRP) computation. In some embodiments, each of the at least one second power offset is associated with a corresponding spatial adaptation pattern. The definition and exemplary embodiments of the spatial adaptation pattern are described above and are, therefore, not repeated here.

In some embodiments, the one or more predefined parameters comprise at least one of: one or more PDCCH transmission parameters for beam failure, one or more PDCCH transmission parameters for out-of-synchronization (out-of-sync) evaluation, one or more PDCCH transmission parameters for in-synchronization (in-sync) evaluation, and one or more resources grouping parameters. In some embodiments, the one or more resources grouping parameters are used to indicate whether different resource configurations (such as SSB resource configurations and RLM-RS resource configurations) can be grouped.

In some embodiments, the first threshold set comprises one or more first thresholds for beam failure detection, wherein each of the one or more first thresholds is associated with at least one of: one or more spatial adaptation patterns, a power offset value set, a block error rate (BLER) of a hypothetical PDCCH transmission, one or more set of hypothetical PDCCH transmission parameters, a downlink radio link quality of a plurality of serving cell beams. In some other embodiments, the first threshold set comprises at least one of: a threshold for beam failure detection, a BLER of a hypothetical PDCCH transmission, and an L1-RSRP threshold for beam failure recovery.

In some embodiments, the second threshold set comprises one or more second thresholds for radio link monitoring, wherein each of the one or more second thresholds is associated with at least one of: a downlink radio link quality of a cell, and an out-of-sync BLER, one of one or more spatial adaptation pattern. In some embodiments, each of the one or more second thresholds is defined as the level at which the downlink radio link cannot be reliably received and shall correspond to the out-of-sync block error rate. The second threshold set may comprise one or more out-of-sync block error rates. In some embodiments, the UE 304 applies the one or more second thresholds to L1-RSRP measurements obtained from an SS/PBCH block. The UE 304 may then apply a pre-determined second threshold to the L1-RSRP measurements obtained for a CSI-RS resource after scaling a respective CSI-RS reception power with a value provided by high layer parameters.

In some examples, the second threshold set comprises one second threshold value. When the second threshold is configured, the UE 304 determines whether out-of-sync occurs in accordance with the second threshold. In some other examples, the second threshold set comprises more than one second threshold values, and each of the more than one second threshold values corresponds to one spatial adaptation pattern. The UE 304 determines whether out-of-sync occurs in accordance with the second threshold and the spatial adaptation pattern.

In some embodiments, the third threshold set comprises one or more third thresholds, wherein each of the one or more third thresholds is associated with at least one of: a downlink radio link quality of the cell, and an in-sync block error rate, one of one or more spatial adaptation pattern. In some embodiments, each of the one or more third thresholds is defined as the level at which the downlink radio link quality can be received with a higher reliability than the reliability associated with a corresponding one of the one or more second thresholds. In some embodiments, each of the one or more third thresholds is associated with a corresponding in-sync block error rate. In some other embodiments, the third threshold set includes one or more in-sync block error rate. In some embodiments, the UE 304 applies each of the one or more third thresholds to the L1-RSRP measurement obtained from a SS/PBCH block. The UE may also apply each of the one or more third thresholds to the L1-RSRP measurement obtained for a CSI-RS resource after scaling a respective CSI-RS reception power with a value provided by high layer parameters.

In some embodiments, the fourth threshold set comprises one or more fourth thresholds for beam failure recovery, wherein each of the one or more fourth thresholds is associated with at least one of: one of one or more spatial adaptation pattern, a downlink radio link quality of the beam, and a power value. In some embodiments, the UE 304 applies at least one of: the one or more third thresholds, and the one or more fourth thresholds to the L1-RSRP measurement obtained from a SS/PBCH block. The UE 304 may also apply a pre-determined threshold to the L1-RSRP measurement obtained for a CSI-RS resource after scaling a respective CSI-RS reception power with a value provided by high layer parameters. In some examples, the fourth threshold set comprises one fourth threshold value. When the second threshold is configured, the UE 304 determines the beam quality in accordance with the second threshold. In some other examples, the fourth threshold set comprises more than one fourth threshold values, and each fourth threshold value corresponds to one spatial adaptation pattern. The UE 304 determines the beam quality in accordance with the fourth threshold and the spatial adaptation pattern.

In some embodiments, the plurality of UE measurements 308 may be associated with at least one of: a plurality of CSI resources, a plurality of sub-CSI resource configurations, a plurality of RLM resource configurations, a plurality of SSB resources, and one or more sets of power offsets between the SSB and the CSI-RS. In some embodiments, the UE 304 performs the plurality of UE measurements 308 according to a plurality of resource configurations, wherein the plurality of resource configurations comprises CSI-RS resources and SSBs. In some embodiments, the plurality of resource configurations may comprise resource configurations on primary cell (PCell), and primary and secondary cell (PSCell), wherein the resource configurations on PCell and PSCell are periodic CSI-RS resources and/or SSBs. In some other embodiments, the plurality of resource configurations may comprise reference signal (RS) resource configurations on secondary cell (SCell), wherein the RS resource configurations are periodic CSI-RS.

In some embodiments, the plurality of UE reports 310 comprises at least one of: one or more L1-RSRP reports, one or more layer-1 signal-to-noise and interference ratio (L1-SINR) reports; one or more beam failure instance indications, one or more out-of-sync indications, one or more in-sync indications, one or more beam failure recovery indications, a maximum acceptable power adaptation value, and at least one acceptable spatial adaptation pattern. In some embodiments, the one or more L1-RSRP reports comprise a first L1-RSRP report, wherein the first L1-RSRP report comprises one or more L1-RSRP values. In some embodiments, only the largest value among the one or more L1-RSRP values is reported in the first L1-RSRP report. In some other embodiments, the N largest values among the one or more L1-RSRP values are reported in the first L1-RSRP report, where N>1. In some embodiments, the one or more L1-RSRP values correspond to at least one of: a CSI resource configuration, a sub-CSI resource configuration, an SSB resource configuration, and an RLM resource configuration.

In some embodiments, the one or more L1-RSRP reports comprise a first plurality of L1-RSRP reports, wherein each of the first plurality of L1-RSRP reports comprises one or more L1-RSRP values. In some embodiments, each of the first plurality of L1-RSRP reports corresponds to one corresponding report configuration. In some embodiments, each of the one or more L1-RSRP reports is associated with a corresponding resource configuration, wherein the corresponding resource configuration comprises at least one of: a CSI resource configuration, a sub-CSI resource configuration, an SSB resource configuration, and an RLM resource configuration. In some embodiments, each of the first plurality of L1-RSRP reports is associated with one corresponding resource configuration. In some other embodiments, at least two of the first plurality of L1-RSRP reports are associated with one corresponding resource configuration. In some other embodiments, each of the first plurality of L1-RSRP reports is associated with one corresponding spatial adaptation pattern. In yet some other embodiments, each of the first plurality of L1-RSRP reports is associated with one corresponding time domain resource allocation.

In some embodiments, each of the first plurality of L1-RSRP reports comprises one or more L1-RSRP value sets, wherein each of the one or more L1-RSRP value sets comprises corresponding one or more L1-RSRP values. In some other embodiments, each of the first plurality of L1-RSRP reports is associated with a corresponding plurality of spatial adaptation patterns. For example, at least one of the first plurality of L1-RSRP reports may comprise a plurality of L1-RSRP value sets, wherein each of the plurality of L1-RSRP value sets comprises one or more L1-RSRP values and is associated with one corresponding spatial adaptation pattern.

In some embodiments, each of the plurality of L1-RSRP value sets is associated with one corresponding resource configuration, wherein the one corresponding resource configuration comprises at least one of: a CSI resource configuration, a sub-CSI resource configuration, an SSB resource configuration, and an RLM resource configuration.

In some embodiments, at least one of the first plurality of L1-RSRP reports comprises M blocks, M>1, wherein each of the M blocks is associated with one corresponding L1-RSRP value set. In some other embodiments, each of the one or more L1-RSRP value sets comprises a corresponding plurality of L1-RSRP values, wherein each corresponding plurality of L1-RSRP values is reported independently. In one embodiment, in each of the one or more L1-RSRP value sets, only the largest measured L1-RSRP value in the UE measurement results is reported in the plurality of UE reports 310. In another embodiment, the N largest measured L1-RSRP values (N≥1) in the UE measurement results are reported in the plurality of UE reports 310.

In some embodiments, the one or more L1-RSRP value sets comprises a baseline L1-RSRP value set, wherein the largest measured L1-RSRP value or the N largest measured L1-RSRP values (N≥1) in the UE measurement results are in the plurality of UE reports 310. Then in the other one or more L1-RSRP value sets that are different from the baseline L1-RSRP value set, the L1-RSRP values are reported in a form of differential L1-RSRP values which are computed with a reference to the largest measured L1-RSRP value or the N largest measured L1-RSRP values (N≥1) in the baseline L1-RSRP value set.

In some embodiments, the L1-RSRP values in at least one of the one or more L1-RSRP value sets are selected and reported in first plurality of L1-RSRP reports. In one embodiment, the selection of the L1-RSRP values in the at least one of the one or more L1-RSRP value sets is performed by the UE 304. In another example, the selection of the L1-RSRP values in the at least one of the one or more L1-RSRP value sets is indicated by a signaling from the BS 302, wherein the signaling comprises a radio resource control (RRC) signaling, a MAC control element (CE) signaling, or a downlink control information (DCI) signaling.

In some embodiments, the one or more L1-SINR reports comprise a first plurality of L1-SINR reports, wherein each of the first plurality of L1-SINR reports comprises one or more L1-SINR values.

In some embodiments, the UE 304 uses a plurality of resource configurations from a candidate set of resource configurations for accessing radio link quality. The one or more beam failure instance indications may be then provided by the UE 304 and sent to higher layers when the radio link quality for all the resource configurations in the plurality of resource configurations is worse than a first threshold. In some embodiments, the candidate set of resource configurations comprises at least one of: one or more CSI resource configurations, one or more sub-CSI resource configurations, and one or more SSB resource configurations. In some embodiments, the first threshold is associated with at least one of: one or more spatial adaptation patterns, a power offset value set, a BLER of a hypothetical PDCCH transmission, and one or more sets of hypothetical PDCCH transmission parameters. In one embodiment, each of the one or more spatial adaptation patterns corresponds to a first threshold. In another embodiment, the first threshold corresponds to one BLER of a hypothetical PDCCH transmission. In another embodiment, each of the one or more spatial adaptation patterns corresponds to a set of hypothetical PDCCH transmission parameters. In yet another embodiment, each of the one or more spatial adaptation patterns corresponds to a plurality of BLERs of a hypothetical PDCCH transmission.

In an exemplary embodiment, four first threshold values BLER-1, BLER-2, BLER-3 and BLER-4 are configured in the first threshold set in the first signaling 306, wherein each of the four first threshold value is associated with a corresponding spatial adaptation pattern. For example: spatial adaptation pattern 1 with full transceiver chains activated corresponds to the first threshold values BLER-1, spatial adaptation pattern 2 with half transceiver chains activated corresponds to the first threshold values BLER-2, spatial adaptation pattern 3 with quarter transceiver chains activated corresponds to the first threshold values BLER-3, and spatial adaptation pattern 4 with ⅛ transceiver chains activated corresponds to the first threshold values BLER-4. When the spatial adaptation pattern 1 is used during the communication (that is, all transceiver chains are activated), the UE 304 uses the threshold BLER-1 to judge whether a beam failure instance indication should be provided. When the spatial adaptation pattern 3 is used during the communication (that is, a quarter of the available transceiver chains are activated), the UE 304 uses the threshold BLER-3 to judge whether a beam failure instance indication should be provided.

In some embodiments, the first threshold is associated with a power offset value set, wherein the power value set is used to compensate the hypothetical PDCCH RE energy to average SSS RE energy ratio and the hypothetical PDCCH DMRS energy to average SSS RE energy ratio of PDCCH transmission parameters for beam failure instance. In another exemplary embodiment, the power offset value set comprises four values C1, C2, C3, and C4, wherein C1, C2, C3, and C4 correspond to spatial adaptation patterns 1, 2, 3, and 4, respectively. When spatial adaptation pattern 1 with full transceiver chains activated is used, the value C1 will be added to the hypothetical PDCCH RE energy to average SSS RE energy ratio and the hypothetical PDCCH DMRS energy to average SSS RE energy ratio of PDCCH transmission parameters for beam failure instance indication.

In some embodiments, the first threshold is a threshold for BLER that is set to 10% error rate, such that a beam failure instance is indicated by the UE 304 when the BLER of a hypothetical PDCCH transmission is higher than the first threshold. In some embodiments, the first threshold is derived based on a plurality of hypothetical PDCCH transmission parameters, wherein the plurality of hypothetical PDCCH transmission parameters comprises at least one of: a number of control orthogonal frequency-division multiplexing (OFDM) symbols, an aggregation level, one or more hypothetical PDCCH resource element (RE) energy to average secondary synchronization signal (SSS) RE energy ratios, one or more hypothetical PDCCH demodulation reference signal (DMRS) energy to average SSS RE energy ratios, one or more hypothetical PDCCH RE energy to average CSI-RS RE energy ratios, one or more hypothetical PDCCH DMRS RE energy to average CSI-RS RE energy ratios, a bandwidth, a sub-carrier spacing, a DMRS precoder granularity, a resource element group (REG) bundle size, a cyclic prefix (CP) length, a mapping method from REG to control channel element (CCE).

In one embodiment, the hypothetical PDCCH RE energy to average SSS RE energy ratio and the hypothetical PDCCH DMRS energy to average SSS RE energy ratio are needed when SSB is used for beam failure detection. In another embodiment, the hypothetical PDCCH RE energy to average CSI-RS RE energy ratio and the hypothetical PDCCH DMRS energy to average CSI-RS RE energy ratio are needed when CSI-RS is used for beam failure detection.

In some embodiments, a plurality of ratio values is associated with at least one of: a hypothetical PDCCH RE energy to average SSS RE energy ratio, a hypothetical PDCCH DMRS energy to average SSS RE energy ratio, a hypothetical PDCCH RE energy to average CSI-RS RE energy ratio, and a hypothetical PDCCH DMRS energy to average CSI-RS RE energy ratio, wherein each of the plurality of ratio values is associated with one corresponding spatial adaptation pattern.

In some embodiments, a plurality of hypothetical PDCCH transmission parameter sets are configured in the UE 304, and each of the plurality of hypothetical PDCCH transmission parameter sets is associated with a corresponding spatial adaptation pattern. In one exemplary embodiment, hypothetical PDCCH transmission parameter set 1 corresponds to spatial adaptation pattern 1 with full transceiver chains activated, hypothetical PDCCH transmission parameter set 2 corresponds to spatial adaptation pattern 2 with half transceiver chains activated, hypothetical PDCCH transmission parameter set 3 corresponds to spatial adaptation pattern 3 with quarter transceiver chains activated, and hypothetical PDCCH transmission parameter set 4 corresponds to spatial adaptation pattern 4 with ⅛ transceiver chains activated. When the spatial adaptation pattern 1 is used, the UE 304 uses the hypothetical PDCCH transmission parameter set 1 to evaluate the PDCCH transmission BLER, and judge whether a beam failure instance indication should be provided.

In some embodiments, the first threshold is derived based on a plurality of hypothetical PDCCH transmission parameters, wherein the plurality of hypothetical PDCCH transmission parameters is associated with a corresponding beam failure instance table, and the corresponding beam failure instance table is associated with one corresponding spatial adaptation pattern.

In some embodiments, when SSB is used for beam failure detection, the plurality of hypothetical PDCCH transmission parameters associated with the corresponding beam failure instance table comprises the hypothetical PDCCH RE energy to average SSS RE energy ratio and the hypothetical PDCCH DMRS energy to average SSS RE energy ratio. In some other embodiment, when CSI-RS is used for beam failure detection, the plurality of hypothetical PDCCH transmission parameters associated with the corresponding beam failure instance table comprises the hypothetical PDCCH RE energy to average CSI-RS RE energy ratio and the hypothetical PDCCH DMRS energy to average CSI-RS RE energy ratio.

In some embodiments, a plurality of beam failure instance tables is used to indicate beam failure, wherein each of the plurality of beam failure instance tables is associated with a corresponding spatial adaptation pattern, wherein each corresponding spatial adaptation pattern is associated with at least one of the following parameters: a corresponding hypothetical PDCCH RE energy to average SSS RE energy ratio, a corresponding hypothetical PDCCH DMRS energy to average SSS RE energy ratio, a corresponding hypothetical PDCCH RE energy to average CSI-RS RE energy ratio, and a corresponding hypothetical PDCCH DMRS energy to average CSI-RS RE energy ratio.

Table 1 and Table 2 illustrate two exemplary embodiments of the beam failure instance table, in accordance with some embodiments of the present disclosure. In some embodiments, each of Table 1 and Table 2 comprises a plurality of PDCCH transmission parameters, for example, two hypothetical PDCCH transmission parameters: “Ratio of hypothetical PDCCH RE energy to average SSS RE energy” and “Ratio of hypothetical PDCCH DMRS energy to average SSS RE energy” as shown in Table 1 and Table 2, respectively. In one embodiment, Table 1 is associated with spatial adaptation pattern 1, and Table 2 is associated with spatial adaptation pattern 2. In some embodiments, the UE 304 performs the plurality of UE measurements 308 based on an SSB, and a first threshold is derived based on the two hypothetical PDCCH transmission parameters shown in Table 1 and Table 2.

TABLE 1
PDCCH transmission parameters for beam failure instance

| Parameter | Value |
|---|---|
| DCI format | 1-0 |
| Number of control OFDM symbols | 2 |
| Aggregation level (CCE) | 8 |
| Ratio of hypothetical PDCCH RE | S1_1 dB |
| energy to average SSS RE energy | |
| Ratio of hypothetical PDCCH DMRS | S1_2 dB |
| energy to average SSS RE energy | |
| Bandwidth (PRBs) | 24 |
| Sub-carrier spacing (kHz) | Same as the SCS of |
| | RMSI CORESET |
| DMRS precoder granularity | REG bundle size |
| REG bundle size | 6 |
| CP length | Normal |
| Mapping from REG to CCE | Distributed |

TABLE 2
PDCCH transmission parameters for beam failure instance

| Parameter | Value |
|---|---|
| DCI format | 1-0 |
| Number of control OFDM symbols | 2 |
| Aggregation level (CCE) | 8 |
| Ratio of hypothetical PDCCH RE energy | S2_1 dB |
| to average SSS RE energy | |
| Ratio of hypothetical PDCCH DMRS | S2_2 dB |
| energy to average SSS RE energy | |
| Bandwidth (PRBs) | 24 |
| Sub-carrier spacing (kHz) | Same as the SCS of |
| | RMSI CORESET |
| DMRS precoder granularity | REG bundle size |
| REG bundle size | 6 |
| CP length | Normal |
| Mapping from REG to CCE | Distributed |

In an exemplary embodiment, spatial adaptation pattern 1 with full transceiver chains activated is used for communication between the BS 302 and the UE 304. The UE 304 may then use Table 1 above to evaluate the PDCCH transmission BLER, and judge whether a beam failure instance indication should be provided. In another exemplary embodiment, spatial adaptation pattern 2 with half transceiver chains activated is used for communication between the BS 302 and the UE 304. The UE 304 may then use Table 2 above to evaluate the PDCCH transmission BLER, and judge whether a beam failure instance indication should be provided. Although two beam failure instance tables are used in the exemplary embodiment, the present disclosure is not limited to two beam failure instance tables, and more than two beam failure instance tables can be used to evaluate the PDCCH transmission BLER.

In yet another exemplary embodiment, the UE 304 performs the plurality of UE measurements 308 base on CSI-RS and a first threshold, wherein the first threshold is derived based on the hypothetical PDCCH transmission parameters shown in Table 3 and Table 4 below. In some embodiments, Table 3 may correspond to a first spatial adaptation pattern, and Table 4 may correspond to a second spatial adaptation pattern.

TABLE 3
PDCCH transmission parameters for beam failure instance

| Parameter | Value |
|---|---|
| DCI format | 1-0 |
| Number of control OFDM symbols | 2 |
| Aggregation level (CCE) | 8 |
| Ratio of hypothetical PDCCH RE energy | C1_1 dB |
| to average CSI-RS RE energy | |
| Ratio of hypothetical PDCCH DMRS | C1_2 dB |
| energy to average CSI-RS RE energy | |
| Bandwidth (PRBs) | 48 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

TABLE 4
PDCCH transmission parameters for beam failure instance

| Parameter | Value |
|---|---|
| DCI format | 1-0 |
| Number of control OFDM symbols | 2 |
| Aggregation level (CCE) | 8 |
| Ratio of hypothetical PDCCH RE energy | C2_1 dB |
| to average CSI-RS RE energy | |
| Ratio of hypothetical PDCCH DMRS | C2_2 dB |
| energy to average CSI-RS RE energy | |
| Bandwidth (PRBs) | 48 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

In some embodiments, the UE 304 estimates the downlink radio link quality and compares it to the one or more second thresholds in order to provide the one or more out-of-sync indications in the plurality of UE reports 310. In some embodiments, each of the one or more second thresholds is associated with at least one of: one or more spatial adaptation pattern, a power offset value set, a BLER of a hypothetical PDCCH transmission, one or more sets of hypothetical PDCCH transmission parameters. In one embodiment, each spatial adaptation pattern is associated with a corresponding second threshold value from the one or more second thresholds. In another embodiment, each of the one or more second thresholds is associated with a corresponding BLER of a hypothetical PDCCH transmission. In yet another embodiment, each of the one or more second thresholds is associated with a corresponding plurality of BLERs of a hypothetical PDCCH transmission.

In some other embodiments, the one or more second thresholds comprise only one single second threshold, wherein the single second threshold corresponds to one BLER of a hypothetical PDCCH transmission. In some embodiments, each spatial adaptation pattern corresponds to a set of hypothetical PDCCH transmission parameters.

In one exemplary embodiment, the one or more second thresholds comprise four BLER values: BLER-1, BLER-2, BLER-3 and BLER-4, wherein each of the four BLER values is associated with a corresponding spatial adaptation pattern. For example, spatial adaptation pattern 1 with full transceiver chains activated may be associated with BLER-1, spatial adaptation pattern 2 with half transceiver chains activated may be associated with BLER-2, spatial adaptation pattern 3 with quarter transceiver chains activated may be associated with BLER-3, and spatial adaptation pattern 4 with ⅛ transceiver chains activated may be associated with BLER-4. When the spatial adaptation pattern 1 is used, the UE 304 may use the threshold BLER-1 to judge whether an out-of-sync indication should be provided. When the spatial adaptation pattern 3 is used, the UE may uses the threshold BLER-3 to judge whether an out-of-sync should be provided.

In another exemplary embodiment, a power offset value set comprises four power offset values P1, P2, P3, and P4, wherein P1, P2, P3 and P4 correspond to spatial adaptation patterns 1, 2, 3 and 4, respectively. When spatial adaptation pattern 1 with full transceiver chains activated is used, P1 will be added to the hypothetical PDCCH RE energy to average SSS RE energy ratio and the hypothetical PDCCH DMRS energy to average SSS RE energy ratio in the PDCCH transmission parameters for out-of-sync evaluation respectively.

In some embodiments, each of the one or more second thresholds is a threshold for BLER of a hypothetical PDCCH transmission, wherein each of the one or more second thresholds is set to 10%, such that a radio link monitoring failure instance is indicated by the UE 304 when the BLER of a hypothetical PDCCH transmission is higher than each of the one or more second thresholds. In some embodiments, each of the one or more second thresholds is derived based on a plurality of hypothetical PDCCH transmission parameters.

In some embodiments, the plurality of hypothetical PDCCH transmission parameters comprises at least one of: a number of control OFDM symbols, an aggregation level, one or more hypothetical PDCCH RE energy to average SSS RE energy ratios, one or more hypothetical PDCCH DMRS energy to average SSS RE energy ratios, a bandwidth, a sub-carrier spacing, a DMRS precoder granularity, a REG bundle size, a CP length, and a mapping method from REG to CCE.

In some embodiments, a plurality of ratio values is associated with at least one of: a hypothetical PDCCH RE energy to average SSS RE energy ratio, a hypothetical PDCCH DMRS energy to average SSS RE energy ratio, wherein each of the plurality of ratio values is associated with one corresponding spatial adaptation pattern.

In some embodiments, a plurality of out-of-sync evaluation tables is used to indicate out-of-sync evaluations, wherein each of the plurality of out-of-sync evaluation tables is associated with a corresponding spatial adaptation pattern, wherein each corresponding spatial adaptation pattern is associated with at least one of the following parameters: a corresponding hypothetical PDCCH RE energy to average SSS RE energy ratio, and a corresponding hypothetical PDCCH DMRS energy to average SSS RE energy ratio.

In an exemplary embodiment, the UE 304 estimates the downlink radio link quality and compares it to a second threshold, wherein the second threshold is derived from the hypothetical PDCCH transmission parameters shown in Table 5 and Table 6 below. In some embodiments, Table 5 may correspond to a first spatial adaptation pattern, and Table 6 may correspond to a second spatial adaptation pattern.

TABLE 5
PDCCH transmission parameters for out-of-sync evaluation

| Parameter | Value for |
|---|---|
| DCI format | 1-0 |
| Number of control OFDM symbols | 2 |
| Aggregation level (CCE) | 8 |
| Ratio of hypothetical PDCCH RE energy | O1_1 dB |
| to average SSS RE energy | |
| Ratio of hypothetical PDCCH DMRS | O1_2 dB |
| energy to average SSS RE energy | |
| Bandwidth (PRBs) | 24 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

TABLE 6
PDCCH transmission parameters for out-of-sync evaluation

| Parameter | Value for |
|---|---|
| DCI format | 1-0 |
| Number of control OFDM symbols | 2 |
| Aggregation level (CCE) | 8 |
| Ratio of hypothetical PDCCH RE energy | O2_1 dB |
| to average SSS RE energy | |
| Ratio of hypothetical PDCCH DMRS | O2_2 dB |
| energy to average SSS RE energy | |
| Bandwidth (PRBs) | 24 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

In some embodiments, the UE 304 estimates the downlink radio link quality and compares it to the one or more third thresholds in order to provide the one or more in-sync indications in the plurality of UE reports 310. In some embodiments, each of the one or more third thresholds is associated with at least one of: one or more spatial adaptation pattern, a power offset value set, a BLER of a hypothetical PDCCH transmission, one or more sets of hypothetical PDCCH transmission parameters. In one embodiment, each spatial adaptation pattern is associated with a corresponding third threshold value from the one or more third thresholds. In another embodiment, each of the one or more third thresholds is associated with a corresponding BLER of a hypothetical PDCCH transmission.

In some other embodiments, the one or more third thresholds comprise only one single third threshold, wherein the single third threshold corresponds to one BLER of a hypothetical PDCCH transmission. In some embodiments, each spatial adaptation pattern corresponds to a set of hypothetical PDCCH transmission parameters.

In an exemplary embodiment, the power offset value set comprises four power offset values P1, P2, P3, and P4, wherein P1, P2, P3 and P4 correspond to spatial adaptation patterns 1, 2, 3 and 4, respectively. When spatial adaptation pattern 1 with full transceiver chains activated is used, P1 will be added to the hypothetical PDCCH RE energy to average SSS RE energy ratio and the hypothetical PDCCH DMRS energy to average SSS RE energy ratio in the PDCCH transmission parameters for in-sync evaluation.

In some embodiments, each of the one or more third thresholds is a threshold for BLER of a hypothetical PDCCH transmission, wherein each of the one or more third thresholds is set to 2%, such that a radio link monitoring failure instance is indicated by the UE 304 when the BLER of a hypothetical PDCCH transmission is higher than at least one of the one or more third thresholds. In some embodiments, each of the one or more third thresholds is derived from a plurality of hypothetical PDCCH transmission parameters.

In some embodiments, the plurality of hypothetical PDCCH transmission parameters comprises at least one of: a number of control OFDM symbols, an aggregation level, one or more hypothetical PDCCH RE energy to average SSS RE energy ratios, one or more hypothetical PDCCH DMRS energy to average SSS RE energy ratios, a bandwidth, a sub-carrier spacing, a DMRS precoder granularity, a REG bundle size, a CP length, and a mapping method from REG to CCE.

In some embodiments, a plurality of ratio values is associated with at least one of: a hypothetical PDCCH RE energy to average SSS RE energy ratio, a hypothetical PDCCH DMRS energy to average SSS RE energy ratio, wherein each of the plurality of ratio values is associated with one corresponding spatial adaptation pattern.

In some embodiments, a plurality of in-sync evaluation tables is used to indicate in-sync evaluations, wherein each of the plurality of in-sync evaluation tables is associated with a corresponding spatial adaptation pattern, wherein each corresponding spatial adaptation pattern is associated with at least one of the following parameters: a corresponding hypothetical PDCCH RE energy to average SSS RE energy ratio, and a corresponding hypothetical PDCCH DMRS energy to average SSS RE energy ratio.

In an exemplary embodiment, the UE 304 estimates the downlink radio link quality and compares it to a third threshold, wherein the third threshold is derived from the hypothetical PDCCH transmission parameters shown in Table 7 and Table 8 below. In some embodiments, Table 7 may correspond to a first spatial adaptation pattern, and Table 8 may correspond to a second spatial adaptation pattern.

TABLE 7
PDCCH transmission parameters for in-sync evaluation

| Parameter | Value |
|---|---|
| DCI payload size | 1-0 |
| Number of control OFDM symbols | 2 |
| Aggregation level (CCE) | 4 |
| Ratio of hypothetical PDCCH RE energy | I1_1 dB |
| to average SSS RE energy | |
| Ratio of hypothetical PDCCH DMRS | I1_2 dB |
| energy to average SSS RE energy | |
| Bandwidth (PRBs) | 24 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

TABLE 8
PDCCH transmission parameters for in-sync evaluation

| Parameter | Value |
|---|---|
| DCI payload size | 1-0 |
| Number of control OFDM symbols | 2 |
| Aggregation level (CCE) | 4 |
| Ratio of hypothetical PDCCH RE energy | I2_1 dB |
| to average SSS RE energy | |
| Ratio of hypothetical PDCCH DMRS | I2_2 dB |
| energy to average SSS RE energy | |
| Bandwidth (PRBs) | 24 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

In some embodiments, the one or more beam failure recovery indications are provided by the UE 304 by estimating the downlink radio link quality and comparing the downlink radio link quality to a pre-determined threshold. In one embodiment, the pre-determined threshold is a fourth threshold from the fourth threshold set. In some other embodiments, the pre-determined threshold is equal to the fourth threshold plus a compensation value X, wherein X can be a positive number, a negative number, or 0. In some embodiments, the UE 304 applies the pre-determined threshold to the L1-RSRP measurement obtained from a SS/PBCH block. The UE 304 then applies the pre-determined threshold to the L1-RSRP measurement obtained for a CSI-RS resource after scaling a respective CSI-RS reception power with a value provided by high layer parameters.

In some embodiments, the UE 304 performs measurements for the radio link monitoring and/or beam failure detection according to a plurality of configurations, wherein each of the plurality of configurations is associated with a corresponding spatial adaptation pattern. Based on the measurement results, the UE 304 may judge whether a radio link failure and/or a beam detection failure occurs in the corresponding spatial adaptation pattern with the plurality of configurations. Then the UE 304 may report one or more acceptable spatial adaptation patterns, wherein in each of the one or more acceptable spatial adaptation patterns, a corresponding radio link failure and/or beam detection failure does not occur.

In some embodiments, the plurality of configurations comprises at least one of: one or more spatial adaptation patterns, one or more CSI resource configurations, one or more sub-CSI resource configurations, one or more SSB resource configurations, one or more RLM-RS resource configurations, one or more first thresholds, one or more second thresholds, one or more third thresholds, a BLER of a hypothetical PDCCH transmission, and one or more sets of hypothetical PDCCH transmission parameters.

In some embodiments, the plurality of UE reports is associated with at least one of: one or more CSI resources, one or more SSB resources, a plurality of PDCCH transmission parameters for out-of-sync evaluation, a plurality of PDCCH transmission parameters for in-sync evaluation, a plurality of PDCCH transmission parameters for beam failure instance, one or more power offsets between SSB and CSI-RS, one or more power offsets between PDSCH and CSI-RS, one or more threshold values associated with beam failure detection, one or more threshold values associated with beam failure recovery, one or more threshold values associated with radio link monitoring, and one or more threshold values associated with radio link recovery.

In some embodiments, a beam failure detection timer is used to control beam failure detection, wherein the beam failure detection timer starts or restarts when at least one of the following conditions is satisfied: at least one spatial adaptation pattern is changed, at least one of a plurality of resource configurations used for beam failure detection is changed.

In some other embodiments, a beam failure indication counter is used to control beam failure detection, wherein the beam failure indication counter is set or reset to 0 when at least one of the following conditions is satisfied: at least one spatial adaptation pattern is changed, at least one of a plurality of resource configurations used for radio link monitoring is changed. In yet some embodiments, a counter is used to calculate the number of out-of-sync indications, wherein the counter is set or reset to 0 when at least one of the following conditions is satisfied: at least one spatial adaptation pattern is changed, at least one of a plurality of resource configurations used for radio link monitoring is changed.

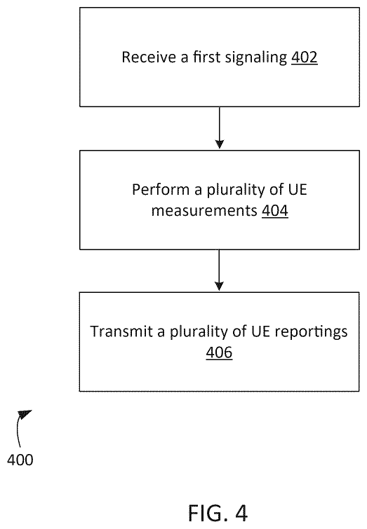

FIG. 4 illustrates an example method 400 for performing CSI measurements and reporting, in accordance with some embodiments. The operations of method 400 presented below are intended to be illustrative. In some embodiments, method 400 may be accomplished with one or more additional operations not described and/or without one or more of the operations discussed. Additionally, the order in which the operations of method 400 are illustrated in FIG. 4 and described below is not intended to be limiting.

At step 402, a first signaling is received at a UE from a BS. In some embodiments, the first signaling comprises at least one of: one or more CSI resource configurations, one or more sub-CSI resource configurations, one or more SSB resource configurations, one or more RLM-RS resource configurations, a first set of power offsets, a second set of power offsets, one or more predefined parameters, a plurality of threshold sets (e.g., a first threshold set, a second threshold set, a third threshold set, a fourth threshold set, etc.), and a plurality of TCI states.

At step 404, a plurality of UE measurements is performed at the UE based on the first signaling received at step 402. In some embodiments, the plurality of UE measurements may be associated with at least one of: a plurality of CSI resources, a plurality of sub-CSI resource configurations, a plurality of RLM resource configurations, a plurality of SSB resources, and one or more sets of power offsets between the SSB and the CSI-RS.

At step 406, a plurality of UE reports are transmitted from the UE to the BS based on the measurements results from the plurality of UE measurements performed at step 404. In some embodiments, the plurality of UE reports comprises at least one of: one or more L1-RSRP reports, one or more beam failure instance indications, one or more out-of-sync indications, one or more in-sync indications, one or more beam failure recovery indications, a maximum acceptable power adaptation value, and at least one acceptable spatial adaptation pattern.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method performed by a first wireless communication device, the method comprising:
receiving a first signaling from a first wireless communication node, wherein the first signaling comprises at least one of:
one or more sub-channel state information (CSI) resource configurations, wherein each of the one or more sub-CSI resource configurations comprises at least one of one or more CSI-RS resources, one or more CSI-RS resource sets, one or more CSI-RS resource settings;
one or more CSI resource configurations, wherein each of the one or more CSI resource configurations comprises at least one of one or more sub-CSI resource configurations, one or more CSI-RS resources, one or more CSI-RS resource sets, one or more CSI-RS resource settings;
one or more synchronization signal block (SSB) resource configurations;
one or more radio link monitoring (RLM) resource configurations, wherein the RLM resource configurations comprises at least one of one or more radio link monitoring reference signal (RLM-RS) resources, failure detection resources; and
a plurality of threshold sets;
performing a plurality of measurements based on the first signaling; and
transmitting a plurality of reports to the first wireless communication node, wherein the plurality of reports is associated with the plurality of measurements.

2. The method of claim 1, wherein the first signaling further comprises at least one of:
at least one first power offset, wherein the at least one first power offset is a ratio of a non-zero power (NZP) CSI-RS energy per resource element (EPRE) to a synchronization signal/physical broadcast channel (SS/PBCH) block EPRE;
at least one second power offset, wherein the at least one second power offset is a compensated power offset of the NZP CSI-RS EPRE to SS/PBCH EPRE;
one or more predefined parameters, wherein the one or more predefined parameters comprise at least one of: one or more physical downlink control channel (PDCCH) transmission parameters for beam failure detections; one or more PDCCH transmission parameters for out-of-synchronization (out-of-sync) evaluations; one or more PDCCH transmission parameters for in-synchronization (in-sync) evaluations; and one or more resources grouping parameters; and
a number of transmission configuration indicator (TCI) states.

3. The method of claim 1, wherein the plurality of threshold sets comprises at least two of:
a first threshold set comprising at least one first threshold, wherein the at least one first threshold is associated with at least one of: a corresponding first spatial adaptation pattern from the plurality of spatial adaptation patterns; a power offset value set; a block error rate (BLER) of a hypothetical physical downlink control channel (PDCCH) transmission; a plurality of hypothetical PDCCH transmission parameters; and a downlink radio link quality of a plurality of serving cell beams;
a second threshold set comprising at least one second threshold, wherein the at least one second threshold is associated with at least one of: a corresponding second spatial adaptation pattern from the plurality of spatial adaptation patterns; a first downlink radio link quality of a cell, and an out-of-synchronization (out-of-sync) BLER;
a third threshold set comprising at least one third threshold, wherein the at least one third threshold is associated with at least one of: a corresponding third spatial adaptation pattern from the plurality of spatial adaptation patterns; a second downlink radio link quality of the cell, and an in-synchronization (in-sync) BLER; and
a fourth threshold set comprising at least one fourth threshold, wherein the at least one fourth threshold is associated with at least one of: a corresponding fourth spatial adaptation pattern from the plurality of spatial adaptation patterns; a third downlink radio link quality of a beam, and a power value.

4. The method of claim 1, wherein the plurality of measurements is associated with at least one of: a plurality of CSI resources; a plurality of sub-CSI resource configurations; a plurality of radio link monitoring (RLM) resource configurations; a plurality of SSB resources; and one or more sets of power offsets between an SSB and a CSI reference signal (RS).

5. The method of claim 1, wherein the plurality of reports comprises at least one of: one or more layer-1 reference signal received power (L1-RSRP) reports; one or more layer-1 signal-to-noise and interference ratio (L1-SINR) reports; one or more beam failure instance indications; one or more out-of-synchronization (out-of-sync) indications; one or more in-synchronization (in-sync) indications; one or more beam failure recovery indications; a maximum acceptable power adaptation value; and at least one acceptable spatial adaptation pattern from the plurality of spatial adaptation patterns.

6. The method of claim 3, wherein the plurality of hypothetical PDCCH transmission parameters comprises at least one of: a plurality of control orthogonal frequency-division multiplexing (OFDM) symbols; an aggregation level; one or more hypothetical PDCCH resource element (RE) energy to average secondary synchronization signal (SSS) RE energy ratios; one or more hypothetical PDCCH demodulation reference signal (DMRS) energy to average SSS RE energy ratios; one or more hypothetical PDCCH RE energy to average CSI-RS RE energy ratios; one or more hypothetical PDCCH DMRS RE energy to average CSI-RS RE energy ratios; a bandwidth; a sub-carrier spacing; a DMRS precoder granularity; a resource element group (REG) bundle size; a cyclic prefix (CP) length; and a mapping method from REG to control channel element (CCE).

7. The method of claim 5, wherein the at least one acceptable spatial adaptation pattern is associated with a hypothetical physical downlink control channel (PDCCH) transmission with no radio link failures or no beam failures.

8. The method of claim 1, wherein each of the plurality of spatial adaptation patterns comprises at least one of:
a first number of active antennas used in a communication between the first wireless communication node and the first wireless communication device;
a second number of activated channels used in the communication between the first wireless communication node and the first wireless communication device;
a third number of active antenna ports used in the communication between the first wireless communication node and the first wireless communication device;
a fourth number of active transceiver chains used in the communication between the first wireless communication node and the first wireless communication device; and
a fifth number of resource configurations for communication between the first wireless communication node and the first wireless communication device.

9. The method of claim 5, wherein each of: the one or more beam failure instance indications, the one or more out-of-sync indications, the one or more in-sync indications, and one or more beam failure recovery indications is based on at least one of:
the first signaling;
one or more L1-RSRP values;
the plurality of threshold sets; and
one or more predefined parameters.

10. A method performed by a first wireless communication node, the method comprising:
transmitting a first signaling to a first wireless communication device, wherein the first signaling comprises at least one of:
one or more sub-channel state information (CSI) resource configurations, wherein each of the one or more sub-CSI resource configurations comprises at least one of one or more CSI-RS resources, one or more CSI-RS resource sets, one or more CSI-RS resource settings;
one or more CSI resource configurations, wherein each of the one or more CSI resource configurations comprises at least one of one or more sub-CSI resource configurations, one or more CSI-RS resources, one or more CSI-RS resource sets, one or more CSI-RS resource settings;
one or more synchronization signal block (SSB) resource configurations;
one or more radio link monitoring (RLM) resource configurations, wherein the RLM resource configurations comprises at least one of one or more radio link monitoring reference signal (RLM-RS) resources, failure detection resources; and
a plurality of threshold sets; and
receiving a plurality of reports from the first wireless communication device, wherein the plurality of reports is generated based on a plurality of measurements performed by the first wireless communication device, wherein the plurality of measurements is performed associated with the first signaling.

11. The method of claim 10, wherein the first signaling further comprises at least one of:
at least one first power offset, wherein the at least one first power offset is a ratio of a non-zero power (NZP) CSI-RS energy per resource element (EPRE) to a synchronization signal/physical broadcast channel (SS/PBCH) block EPRE;
at least one second power offset, wherein the at least one second power offset is a compensated power offset of the NZP CSI-RS EPRE to the SS/PBCH block EPRE;
one or more predefined parameters, wherein the one or more predefined parameters comprise at least one of: one or more physical downlink control channel (PDCCH) transmission parameters for beam failure detections; one or more PDCCH transmission parameters for out-of-synchronization (out-of-sync) evaluations; one or more PDCCH transmission parameters for in-synchronization (in-sync) evaluations; and one or more resources grouping parameters; and
a number of transmission configuration indicator (TCI) states.

12. The method of claim 10, wherein the plurality of threshold sets comprises at least two of:
a first threshold set comprising at least one first threshold, wherein the at least one first threshold is associated with at least one of: a first spatial adaptation pattern from the plurality of spatial adaptation patterns; a power offset value set; a block error rate (BLER) of a hypothetical physical downlink control channel (PDCCH) transmission; a plurality of hypothetical PDCCH transmission parameters; and a downlink radio link quality of a plurality of serving cell beams;
a second threshold set comprising at least one second threshold, wherein the at least one second threshold is associated with at least one of: a second spatial adaptation pattern from the plurality of spatial adaptation patterns; a first downlink radio link quality of a cell, and an out-of-synchronization (out-of-sync) BLER;
a third threshold set comprising at least one third threshold, wherein the at least one third threshold is associated with at least one of: a third spatial adaptation pattern from the plurality of spatial adaptation patterns; a second downlink radio link quality of the cell, and an in-synchronization (in-sync) BLER; and
a fourth threshold set comprising at least one fourth threshold, wherein the at least one fourth threshold is associated with at least one of: a fourth spatial adaptation pattern from the plurality of spatial adaptation patterns; a third downlink radio link quality of a beam, and a power value.

13. The method of claim 10, wherein the plurality of measurements is associated with at least one of: a plurality of CSI resources; a plurality of sub-CSI resource configurations; a plurality of radio link monitoring (RLM) resource configurations; a plurality of SSB resources; and one or more sets of power offsets between an SSB and a CSI reference signal (RS).

14. The method of claim 10, wherein the plurality of reports comprises at least one of: one or more layer-1 reference signal received power (L1-RSRP) reports; one or more layer-1 signal-to-noise and interference ratio (L1-SINR) reports; one or more beam failure instance indications; one or more out-of-synchronization (out-of-sync) indications; one or more in-synchronization (in-sync) indications; one or more beam failure recovery indications; a maximum acceptable power adaptation value; and at least one acceptable spatial adaptation pattern from the plurality of spatial adaptation patterns.

15. The method of claim 12, wherein the plurality of hypothetical PDCCH transmission parameters comprises at least one of: a plurality of control orthogonal frequency-division multiplexing (OFDM) symbols; an aggregation level; one or more hypothetical PDCCH resource element (RE) energy to average secondary synchronization signal (SSS) RE energy ratios; one or more hypothetical PDCCH demodulation reference signal (DMRS) energy to average SSS RE energy ratios; one or more hypothetical PDCCH RE energy to average CSI-RS RE energy ratios; one or more hypothetical PDCCH DMRS RE energy to average CSI-RS RE energy ratios; a bandwidth; a sub-carrier spacing; a DMRS precoder granularity; a resource element group (REG) bundle size; a cyclic prefix (CP) length; and a mapping method from REG to control channel element (CCE).

16. The method of claim 14, wherein the at least one acceptable spatial adaptation pattern is associated with a hypothetical physical downlink control channel (PDCCH) transmission with no radio link failures or no beam failures.

17. The method of claim 10, wherein each of the plurality of spatial adaptation patterns comprises at least one of:
a first number of active antennas used in a communication between the first wireless communication node and the first wireless communication device;
a second number of activated channels used in the communication between the first wireless communication node and the first wireless communication device;
a third number of active antenna ports used in the communication between the first wireless communication node and the first wireless communication device;
a fourth number of active transceiver chains used in the communication between the first wireless communication node and the first wireless communication device; and
a fifth number of resource configurations for communication between the first wireless communication node and the first wireless communication device.

18. The method of claim 14, wherein each of: the one or more beam failure instance indications, the one or more out-of-sync indications, the one or more in-sync indications, and one or more beam failure recovery indications is based on at least one of:
the first signaling;
one or more L1-RSRP values;
the plurality of threshold sets; and
one or more predefined parameters.

19-22. (canceled)

23. A non-transitory computer-readable medium storing computer-executable instructions that when executed by a computer perform a method according to claim 1.

24. A non-transitory computer-readable medium storing computer-executable instructions that when executed by a computer perform a method according to claim 10.
